(19) United States
(12) Patent Application Publication
(10) Pub. No.: US 2018/0103089 A1
(43) Pub. Date: Apr. 12, 2018

(54) METHODS FOR DETERMINING PROCESSING NODES FOR EXECUTED TASKS AND APPARATUSES USING THE SAME

(71) Applicant: Synology Inc., Taipei (TW)

(72) Inventors: Chih-Hao CHEN, Taipei (TW); Ting-Fu LIAO, Taipei (TW); Ning-Yen CHIEN, Taipei (TW); Tzu-Lin CHANG, Taipei (TW)

(21) Appl. No.: 15/651,118

(22) Filed: Jul. 17, 2017

(30) Foreign Application Priority Data
Oct. 11, 2016 (TW) 105132698

(51) Int. Cl. H04L 29/08

(52) U.S. Cl. CPC H04L 67/1008; H04L 47/805; H04L 67/322; H04L 67/1025

(57) ABSTRACT

The invention introduces a method for determining processing nodes for executed tasks, performed by a processor when loading and executing a daemon, and containing at least the following steps: obtaining a first evaluation score associated with usages of I/O devices of a first node by a task in a time interval; obtaining a second evaluation score associated with usages of I/O devices of a second node by the task in the time interval, wherein the task is executed by a processor of the first node; and when the second evaluation score is higher than the first evaluation score, switching execution of the task to a processor of the second node.

### CROSS REFERENCE TO RELATED APPLICATIONS

This Application claims the benefit of Taiwan Patent Application No. 105132698, filed on Oct. 11, 2016, the entirety of which is incorporated by reference herein.

### BACKGROUND

### Technical Field

The present invention relates to task management of an OS (Operating System), and in particular, to methods for determining processing nodes for executed tasks and apparatuses using the same.

### Description of the Related Art

NUMA (Non-uniform memory access) is a computer memory design used in multiprocessing to improve the waiting time for processing the accessing of data stored in memory, where the memory access time depends on the memory location relative to the processor. NUMA provides the architecture, in which each processor (or each group of processors) is allocated to a respective memory (that is, a local memory). Under NUMA, a processor can access its own local memory faster than a non-local memory (such as a memory local to another processor or a memory shared between processors). The conventional OS (Operating System) kernel determines which processing node of NUMA is used to execute a task according to its frequencies for accessing local and non-local memories. However, the execution efficiency does not depend solely on the factor of memory access. Thus, it is desirable to have methods for determining processing nodes for executed tasks and apparatuses using the same to improve execution efficiency by taking other factors into account.

### BRIEF SUMMARY

An embodiment of the invention introduces a method for determining processing nodes for executed tasks, performed by a processor when loading and executing a daemon, and comprising: obtaining a first evaluation score associated with usages of I/O devices of a first node by a task in a time interval; obtaining a second evaluation score associated with usages of I/O devices of a second node by the task in the time interval, in which the task is executed by a processor of the first node; and when the second evaluation score is higher than the first evaluation score, switching execution of the task to a processor of the second node.

An embodiment of the invention introduces an apparatus for determining processing nodes for executed tasks including: a first node and a second node, in which the first node includes a processor loading and executing a daemon and a task. The daemon obtains a first evaluation score associated with usages of I/O devices of the first node by the task in a time interval; obtains a second evaluation score associated with usages of I/O devices of the second node by the task in the time interval; and, when the second evaluation score is higher than the first evaluation score, switches execution of the task to the processor of the second node.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is a schematic diagram of the network architecture of the computation apparatus according to an embodiment of the invention;

FIG. 2 is a flowchart for a method for determining processing nodes for executed tasks according to an embodiment of the invention;

FIG. 3 is a schematic diagram illustrating the software architecture containing a daemon and an OS according to an embodiment of the invention;

FIGS. 4A and 4B are schematic diagrams of I/O devices used by tasks according to an embodiment of the invention.

### DETAILED DESCRIPTION

The following description is of the well-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

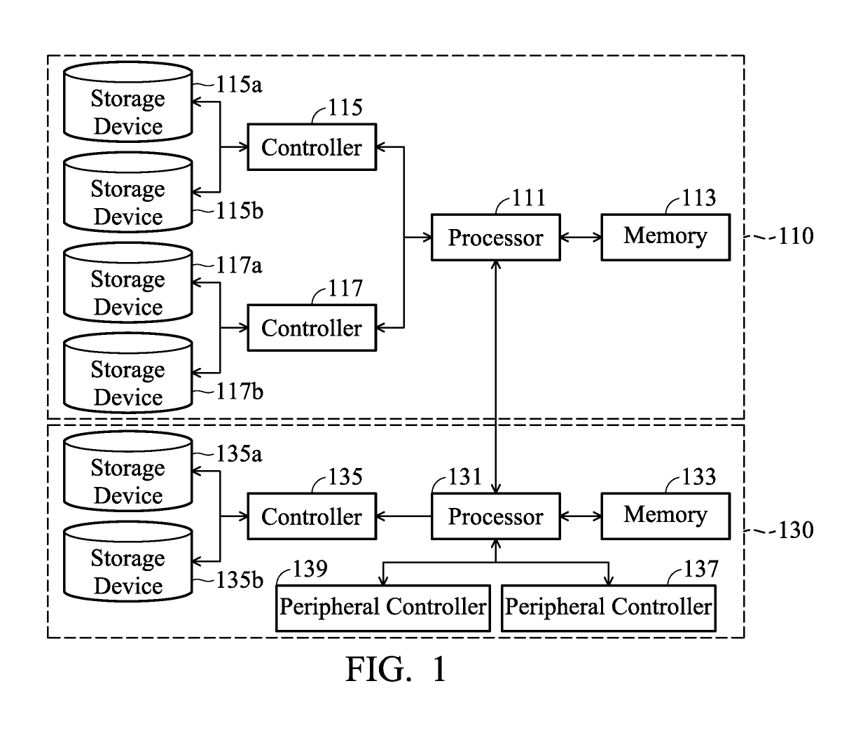

FIG. 1 is a schematic diagram of the network architecture of the computation apparatus according to an embodiment of the invention. The network architecture contains at least two nodes 110 and 130. The hardware architecture may conform to the specification of NUMA. The processors 111 and 131 manage a wide range of components of the processing nodes (referred to as nodes as follows for brevity) 110 and 130, respectively. Any of the processors 111 and 131 can be implemented in numerous ways, such as with general-purpose hardware (e.g., the general-purposed processor, the general-purposed graphics processor, or any processor capable of computations) that is programmed using software instructions, macrocode or microcode to perform the functions recited herein. Any of the processors 111 and 131 may contain ALUs (Arithmetic and Logic Units) and bit shifters. The ALUs are responsible for performing Boolean operations, such as AND, OR, NOT, NAND, NOR, XOR, XNOR, or others, and the bit shifters are responsible for performing bitwise shifting operations and bitwise rotations. A memory 113 connecting to the processor 111 is referred to as the local memory of the node 110, and a memory 133 connecting to the processor 131 is referred to as the local memory of the node 130. The memories 113 and 133 are RAMs (Random Access Memories) for storing necessary data in execution, such as variables, data tables, data abstracts, or others. The processors 111 or 131 may provide arbitrary addresses at address pins, and obtain data of the addresses or provide data to be written in the addresses through data pins of the memories in real-time. The processors 111 or 131 may access data of the local memory directly and may use the local memory of another node via an interconnect interface. For example, the processor 111 may communicate with the processor 131 to access data of the memory 133 via the Intel Quick Path Interconnect or the CSI (Common System Interface). The memory 133 may be referred to as a cross-node memory of the processor 111, and vice versa. It should be understood that the quantity of nodes is not limited to two nodes of the hardware architecture of the computation apparatus as shown in FIG. 1. In practice, the hardware architecture of the computation apparatus may contain more nodes than are shown in FIG. 1.

In some embodiments, the hardware of the node 110 (hereinafter referred to as node 0) is configured to provide only a data-storage service. Specifically, the processor 111 may access data of storage devices 115a and 115b via a controller 115 and access data of storage devices 117a and 117b via a controller 117. The storage devices 115a, 115b, 117a and 117b may be arranged into RAID (Redundant Array of Independent Disks) to provide a secure data-storage environment. The processor 111 is more suitable for executing tasks of mass-storage access. The storage devices 115a, 115b, 117a and 117b may provide non-volatile storage space for storing a wide range of electronic files, such as Web pages, documents, audio files, video files, etc. It should be understood that the processor 111 may connect more or fewer controllers and each controller may connect more or fewer storage devices and the invention should not be limited thereto.

In some embodiments, the hardware of the node 130 (hereinafter referred to as node 1) is configured to provide data-storage service and communications with peripherals. Specifically, the processor 131 may access data of storage devices 135a and 135b via a controller 135 and communicate with peripherals via peripheral controller 137 or 139. The peripheral controller 137 or 139 may be utilized to communicate with one I/O device. The I/O device may be a LAN (Local Area Network) communications module, a WLAN (Wireless Local Area Network), or a Bluetooth communications module, such as the IEEE 802.3 communications module, the 802.11x communications module, the 802.15x communications module, etc., to communicate with other electronic apparatuses using a given protocol. The I/O device may be a USB (Universal Serial Bus) module. The I/O device may be an input device, such as a mouse, a touch panel, etc., to generate position signals of the mouse pointer. The I/O device may be a display device, such as a TFT-LCD (Thin film transistor liquid-crystal display) panel, an OLED (Organic Light-Emitting Diode) panel, or others, to display input letters, alphanumeric characters and symbols, dragged paths, drawings, or screens provided by an application for the user to view. The processor 131 is more suitable for executing tasks of numerous I/O data transceiving. It should be understood that the processor 131 may connect more or fewer controllers and each controller may connect more or fewer storage devices and the invention should not be limited thereto. Furthermore, the processor 131 may connect more or fewer peripheral controllers and the invention should not be limited thereto.

The storage devices 115a, 115b, 117a and 117b may be referred to as local storage device of the processor 111 and the processor 111 or 131 may access data of the local storage device directly. The processor 111 may communicate with the processor 131 to use the storage devices 135a and 135b of the node 130 via the interconnect interface. The storage devices 135a and 135b may be referred to as the cross-node storage devices of the processor 111. Moreover, the processor 111 may communicate with the processor 131 to use the peripheral controllers 137 and 139 of the node 130 via the interconnect interface. The peripheral controllers 137 and 139 may be referred to as the cross-node peripheral controllers of the processor 111.

In some implementations, the OS kernel determines which one of the processors 111 and 131 is used to execute a task according to its frequencies for accessing local and cross-node memories. However, execution efficiency does not depend solely on memory access. In some hardware installations, the execution efficiency of a task may be greatly affected by the use of storage devices and I/O devices. Thus, embodiments of the invention introduce methods for determining processing nodes for executed tasks, which are practiced by a daemon when being loaded and executed by the processor 111 or 131. In a multitasking OS, a daemon is a computer program that runs as a background task after system booting, rather than being under the direct control of the user. When a task is executed by the processor 111 of the node 110, the daemon periodically obtains a first evaluation score associated with usages of the I/O devices of the node 110 by the task in a time interval and a second evaluation score associated with usage of the I/O devices of the node 130 by the task in the time interval. When the second evaluation score is higher than the first evaluation score, the execution of the task is switched to the processor 131 of the node 130.

The tasks described in embodiments of the invention are the minimum units that can be scheduled in the OS, including arbitrary processes, threads and kernel threads, for example, a FTP (File Transfer Protocol) server process, a keyboard driver process, an I/O interrupt thread, etc.

Assume that the daemon is preset to be executed by the processor 111 and I/O policies are preset to be stored in the storage device 115a: The I/O policies may be practiced in a file of a file system, a data table of a relational database, an object of an object database, or others, and contain usage weights of different I/O device types (such as storage devices and peripherals) for each application. Exemplary I/O policies are provided as follows:

TABLE 1

| Application | Usage weight of storage | Usage weight of |
|---|---|---|
| ID | devices | peripherals |
| A | 1 | 2 |
| B | 1 | 1 |
| C | 2 | 1 |

As to the application A, its usage weight of peripherals being higher than that of storage devices means that the application A theoretically uses peripherals more frequently than storage devices. As to the application C, its usage weight of storage devices being higher than that of peripherals means that the application C theoretically uses storage devices more frequently than peripherals. As to the application B, its usage weight of storage devices being the same as that of peripherals means that the application B theoretically uses storage devices substantially equal to peripherals. Although table 1 describes the usage weights as integers, those skilled in the art may devise usage weights with other types of numbers and the invention should not be limited thereto. For example, the usage weights of storage devices and peripherals for the application A may be set to 0.33 and 0.67, respectively, and the usage weights of storage devices and peripherals for the application B may be set to 0.5 and 0.5, respectively. The memory 113 is used to store and maintain evaluation scores of storage devices and peripherals for each task, thereby enabling the daemon to determine whether each task is to be executed by the processor 111 or the processor 131. The memory 113 may store an evaluation table to facilitate the calculation of evaluation scores and the determination of nodes for each task. The evaluation table may be practiced in one two-dimensional array, multiple one-dimensional arrays, or similar but different data structures. An exemplary evaluation table is provided below:

TABLE 2

| | I/O policies | | Node 0 | | Node 1 | | | | |
|---|---|---|---|---|---|---|---|---|---|
| | Storage | | Usage | Usage | Usage | Usage | Evaluation | | |
| Task | devices | Peripherals | status | status | status | status | scores | | |
| ID | (S) | (P) | of S | of P | of S | of P | Node 0 | Node 1 | Result |

T1
T2

The evaluation table contains multiple records and each record stores necessary information for calculating evaluation scores for one task. For example, the evaluation table contains records of tasks T1 and T2. Each record stores a task ID, the I/O policies of the application associated with the task, the statuses indicating how has the task used storage devices and peripherals of the node 110 and storage devices and peripherals of the node 130, the evaluation scores of the node 110 and the node 130, and a determination result. The statuses indicating how has the task used I/O devices of different types of a particular node in the time interval are represented by numbers. In some embodiments, the number may indicate whether the task has used I/O devices of a particular type of a particular node in the time interval, where “1” indicates yes and “0” indicates no. In some embodiments, the number may indicate the quantity of I/O devices of a particular type of a particular node, which has/have been used by the task in the time interval.

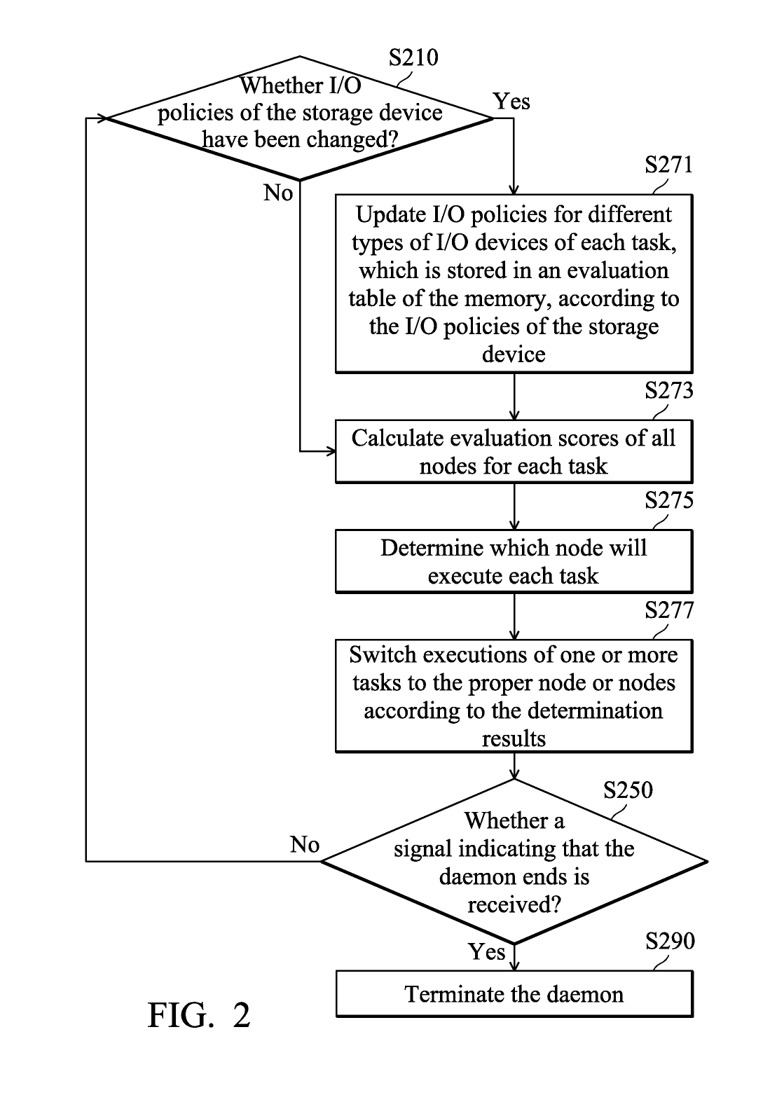

FIG. 2 is a flowchart for a method for determining processing nodes for executed tasks according to an embodiment of the invention. Assume that the processor 111 is preset to execute the daemon: A loop is periodically performed, such as every 10 seconds, until the daemon ends (the “Yes” path of step S250). For example, when detecting a signal indicating a system shutdown, the processor 111 terminates the daemon. The processor 111 sets a polling timer to count to a predefined time, such as 10 seconds. When counting to the predefined time, the polling timer issues an interrupt to the daemon to start the loop. In each iteration, the processor 111 determines whether the execution of each task needs to be switched to another node according to the I/O policies of the storage device 115a and the statuses indicating how has this task used I/O devices of different types of the nodes in a time interval. When it is determined that the execution of any task needs to be switched, the execution of this task is switched to the processor of a proper node.

Although the embodiments describe how the processor 111 is used to execute the daemon by default, it is not intended to limit the daemon to only being executed by the processor 111. The execution of the daemon can be migrated to another processor. The OS may migrate the daemon's execution to another processor for a particular purpose or at a specific moment and the invention should not be limited thereto.

Specifically, the processor 111 detects whether the I/O policies of the storage device 115a have been changed (step S210). In some embodiments of step S210, when the hardware installation has been changed (such as a new storage device or peripheral has been inserted into a node, or a storage device or peripheral has been removed from a node, etc.), the I/O policies of the storage device 115a are updated accordingly. In some other embodiments of step S210, the I/O policies of the storage device 115a are updated via MMI (Man Machine Interface) by the user. When the I/O policies of the storage device 115a have been changed (the “Yes” path of step S210), the processor 111 updates the I/O policies for the different types of I/O devices of each task, which are stored in the evaluation table of the memory 113, according to the I/O policies of the storage device 115a (step S271), calculates evaluation scores of all nodes for each task according to the updated I/O policies for different types of I/O devices of this task and the usage statuses of different types of I/O devices by this task in the time interval, and writes the calculated evaluation scores in the evaluation table of the memory 113 (step S273), determines which node will execute each task according to the calculation results of the evaluation table, and writes the determination results in the evaluation table of the memory 113 (step S275), and, if required, switches the execution of one or more tasks to the proper node or nodes according to the determination results produced in step S275 (step S277). When the I/O policies of the storage device 115a have not been changed (the “No” path of step S210), the processor 111 calculates the evaluation scores of all nodes for each task according to the I/O policies for different types of I/O devices of this task, which are stored in the evaluation table of the memory 113, and the usage statuses of different types of I/O devices by this task in the time interval, and writes the calculated evaluation scores in the evaluation table of the memory 113 (step S273), determines which node will execute each task according to the calculation results of the evaluation table, and writes the determination results in the evaluation table of the memory 113 (step S275), and, if required, switches the executions of one or more tasks to proper node or nodes according to the determination results (step S277).

In step S271, the processor 111 may repeatedly perform a loop for updating the I/O policies for different types of I/O devices of each task, which is stored in the evaluation table of the memory 113. The memory 113 may store information regarding an application associated with each executed task. In each iteration, the processor 111 selects a task of the evaluation table, which has not been updated, searches for the application that this task is associated with according to the information stored in the memory 113, searches usage weights of different I/O device types for the associated application according to the I/O policies of the storage device 115a, and updates the usage weights of different I/O device types of this task of the evaluation table with the found ones. For example, when tasks T1 and T2 are respectively associated with applications A and C, the updated evaluation table is as follows:

TABLE 3

| | I/O policies | | Node 0 | | Node 1 | | | | |
|---|---|---|---|---|---|---|---|---|---|
| | Storage | | Usage | Usage | Usage | Usage | Evaluation | | |
| Task | devices | Peripherals | status | status | status | status | scores | | |
| ID | (S) | (P) | of S | of P | of S | of P | Node 0 | Node 1 | Result |

| | | |
|---|---|---|
| T1 | 1 | 2 |
| T2 | 2 | 1 |

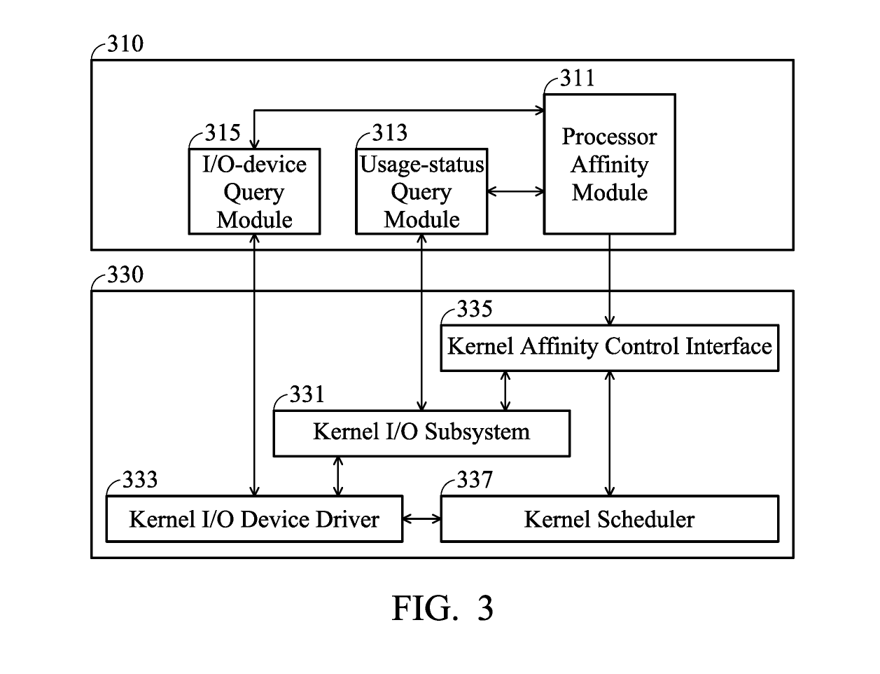

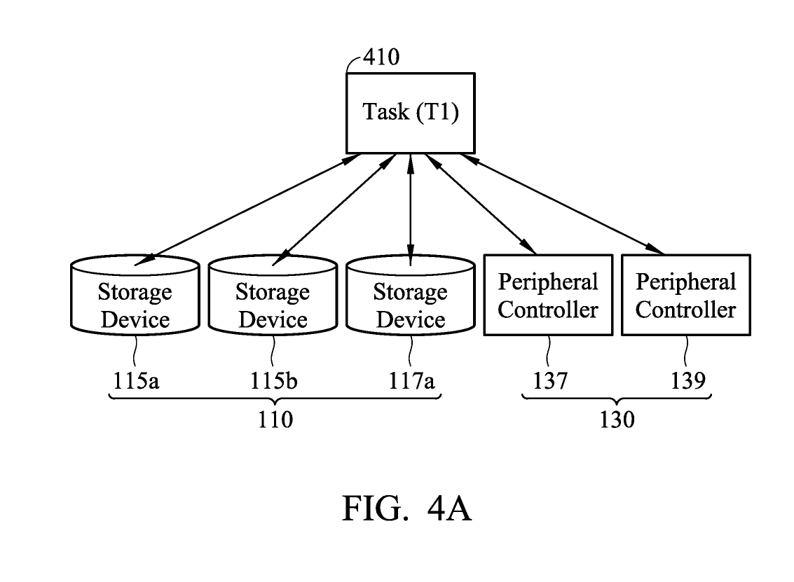

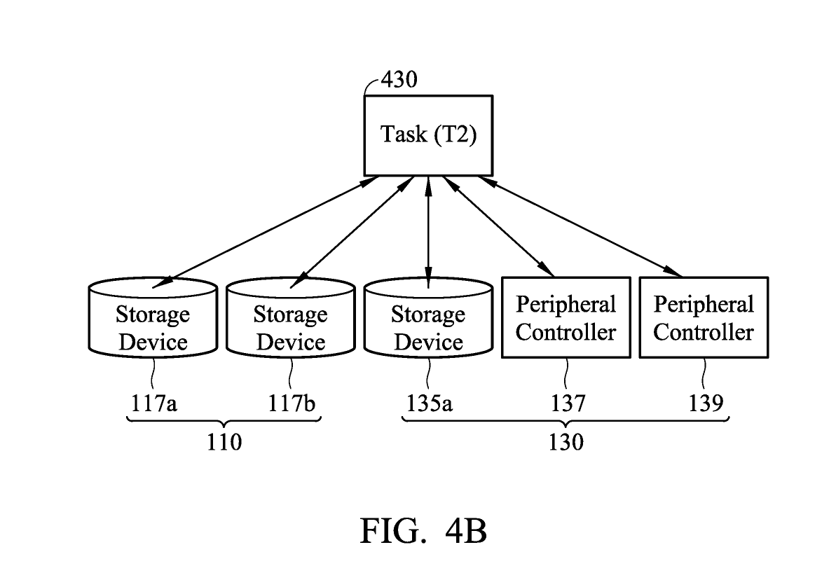

In step S273, specifically, the daemon may obtain the statuses indicating how has each task used the I/O devices of different types of different nodes in the time interval via API (Application Programming Interface) by the OS. FIG. 3 is a schematic diagram illustrating the software architecture containing a daemon and an OS according to an embodiment of the invention. API provided by an OS 330 at least includes a kernel I/O Subsystem 331, a kernel I/O device driver 333, and kernel affinity control interface 335 and a kernel scheduler 337. A daemon 310 at least contains a processor affinity module 311, a usage-status query module 313 and an I/O-device query module 315. The processor affinity module 311 is the main program of the daemon 310 to coordinate with the usage-status query module 313 and the I/O-device query module 315 to complete the aforementioned step. The processor affinity module 311 queries profile information of each node, which includes the type and the ID of each I/O device (such as the storage device, the peripheral, etc.), to the kernel I/O device driver 333 via the I/O-device query module 315. In addition, the processor affinity module 311 may repeatedly perform a loop to update the statuses indicating how has each task used the I/O devices in the time interval, which is stored in the evaluation table. In each iteration, the processor affinity module 311 selects a task of the evaluation table, which has not been updated, queries the statuses indicating how has this task used the I/O devices in the time interval to the kernel I/O Subsystem 331 via the usage-status query module 313. The processor affinity module 311 organizes the query results from the usage-status query module 313 and the I/O-device query module 315 and writes them in the evaluation table of the memory 113. FIGS. 4A and 4B are schematic diagrams of I/O devices used by tasks according to an embodiment of the invention. Refer to FIG. 4A. The task T1 410 has used the storage devices 115a, 115b and 117a of the node 110 and peripheral controllers 137 and 139 of the node 130 in the time interval, therefore, the quantity of the used storage devices of the node 110 is 3 and the quantity of the used peripheral controllers or peripherals of the node 130 is 2. Refer to FIG. 4B. The task T2 430 has used the storage devices 117a and 117b of the node 110 and the storage device 135a and peripheral controllers 137 and 139 of the node 130 in the time interval, therefore, the quantity of the used storage devices of the node 110 is 2, the quantity of the used storage device of the node 130 is 1 and the quantity of the used peripheral controllers or peripherals of the node 130 is 2. The updated evaluation table is provided as follows:

TABLE 4

| | I/O policies | | Node 0 | | Node 1 | | | | |
|---|---|---|---|---|---|---|---|---|---|
| | Storage | | Usage | Usage | Usage | Usage | Evaluation | | |
| Task | devices | Peripherals | status | status | status | status | scores | | |
| ID | (S) | (P) | of S | of P | of S | of P | Node 0 | Node 1 | Result |

| | | | | | | |
|---|---|---|---|---|---|---|
| T1 | 1 | 2 | 3 | 0 | 0 | 2 |
| T2 | 2 | 1 | 2 | 0 | 1 | 2 |

In some embodiments, the affinity module 311 may use Equation (1) to calculate evaluation scores associated with the node 110 for each task:

S1=Σᵢ₌₁^{m1}(wᵢ×c_{1,i}),

where S1 represents the evaluation score associated with the node 110, m1 represents the total amount of types of I/O devices of the node 110, wᵢ represents the usage weight of the i^{th} type of I/O devices for the application associated with this task, and c_{1,i} represents the status indicating how has this task used the i^{th} type of I/O devices of the node 110 in the time interval. The affinity module 311 may use Equation (2) to calculate evaluation scores associated with the node 130 for each task:

S2=Σᵢ₌₁^{m2}(wᵢ×c_{2,i}),

where S2 represents the evaluation score associated with the node 130, m2 represents the total amount of types of I/O devices of the node 130, wᵢ represents the usage weight of the i^{th} type of I/O devices for the application associated with this task, and c_{2,i}, represents the status indicating how has this task used the i^{th} type of I/O devices of the node 130 in the time interval. Subsequently, the processor affinity module 311 writes the calculation results in the evaluation table of the memory 113. The updated evaluation table is provided as follows:

TABLE 5

| | I/O policies | | Node 0 | | Node 1 | | | | |
|---|---|---|---|---|---|---|---|---|---|
| | Storage | | Usage | Usage | Usage | Usage | Evaluation | | |
| Task | devices | Peripherals | status | status | status | status | scores | | |
| ID | (S) | (P) | of S | of P | of S | of P | Node 0 | Node 1 | Result |
| T1 | 1 | 2 | 3 | 0 | 0 | 2 | 3 | 4 | |
| T2 | 2 | 1 | 2 | 0 | 1 | 2 | 2 | 5 | |

In other embodiments, the processor affinity module 311 may omit the usage weight of the i^{th} type of I/O devices for the application associated with this task. The processor affinity module 311 may use Equation (3) to calculate evaluation scores associated with the node 110 for each task:

S1=Σᵢ₌₁^{m1}c_{2,i}.

The processor affinity module 311 may use Equation (4) to calculate evaluation scores associated with the node 130 for each task:

S2=Σᵢ₌₁^{m2}c_{2,i}.

In step S275, for each specific task, the processor affinity module 311 determines the node with the highest evaluation score to execute this task and writes the decisions in the evaluation table of the memory 113. The updated evaluation table is provided as follows:

TABLE 6

| | I/O policies | | Node 0 | | Node 1 | | | | |
|---|---|---|---|---|---|---|---|---|---|
| | Storage | | Usage | Usage | Usage | Usage | Evaluation | | |
| Task | devices | Peripherals | status | status | status | status | scores | | |
| ID | (S) | (P) | of S | of P | of S | of P | Node 0 | Node 1 | Result |
| T1 | 1 | 2 | 3 | 0 | 0 | 2 | 3 | 4 | Node 1 |
| T2 | 2 | 1 | 2 | 0 | 1 | 2 | 2 | 5 | Node 1 |

The memory 113 may store information indicating which node is currently executing each task. In step S277, specifically, the processor affinity module 311 may repeatedly perform a loop to move each task that needs to be switched to a processor of a proper node to be executed. In each iteration, the processor affinity module 311 selects from the evaluation table a task that has not been processed, and determines whether the execution of this task needs to be switched to a processor of a proper node according to the decision of the evaluation table for this task and information indicating which node is currently executing this task. When determining that this task needs to be switched, the processor affinity module 311 instructs the kernel affinity control interface 335 to switch execution of this task to the determined node. Subsequently, the kernel affinity control interface 335, through the kernel scheduler 337, moves the context of this task to the memory of the determined node, and arranges this task in a schedule of the processor of the determined node. Assume that the task T1 is currently executed by the processor 111 of the node 110: The processor affinity module 311 instructs the kernel affinity control interface 335 to switch the execution of the task T1 to the node 130. It should be understood that the kernel affinity control interface 335 may be loaded and executed by the processor 111 or 131.

In some embodiments, those skilled in the art may devise the aforementioned method to further take usage rates of the processors and access frequencies to the memories into account for determining whether execution of a task needs to switch to the processor of another node. For example, when a task is executed by the processor 111 of the node 110, the daemon periodically obtains a first evaluation score associated with usages of the I/O devices, the processor and the memory of the node 110 by the task in a time interval and a second evaluation score associated with usages of the I/O devices, the processor and the memory of the node 130 by the task in the time interval. When the second evaluation score is higher than the first evaluation score, the execution of the task is switched to the processor 131 of the node 130.

Although the embodiment has been described as having specific elements in FIG. 1, it should be noted that additional elements may be included to achieve better performance without departing from the spirit of the invention. While the process flow described in FIG. 2 includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining processing nodes for executed tasks, performed by a processor when loading and executing a daemon, comprising:
obtaining a first evaluation score associated with usages of I/O devices of a first node by a task in a time interval;
obtaining a second evaluation score associated with usages of I/O devices of a second node by the task in the time interval, wherein the task is executed by a processor of the first node; and
when the second evaluation score is higher than the first evaluation score, switching execution of the task to a processor of the second node.

2. The method of claim 1, wherein the daemon is a computer program that runs as a background task after system booting.

3. The method of claim 1, wherein the first node comprises a first type of I/O devices and the second node comprises the first type of I/O devices and a second type of I/O devices.

4. The method of claim 3, wherein the first type of I/O devices are storage devices and the second type of I/O devices are peripherals.

5. The method of claim 1, comprising:
obtaining an application associated with the task; and
obtaining I/O policies of a first type of I/O devices and a second type of I/O devices associated with the application.

6. The method of claim 5, wherein the daemon reads the I/O policies of the first type of I/O devices and the second type of I/O devices associated with the application from a storage device.

7. The method of claim 5, wherein the I/O policies of the first type of I/O devices and the second type of I/O devices associated with the application comprises a first weight and a second weight, the first evaluation score is calculated by an Equation:
S1=Σᵢ₌₁^{m1}(wᵢ×c_{1,i}),
S1 represents the first valuation score, m1 represents a total amount of types of I/O devices of the first node, wᵢ represents the i^{th} weight and c_{1,i} represents a status indicating how has the task used the i^{th} type of I/O devices of the first node in the time interval, and the second evaluation score is calculated by an Equation:
S2=Σᵢ₌₁^{m2}(wᵢ×c_{2,i}),
S2 represents the second valuation score, m2 represents a total amount of types of I/O devices of the second node, w₁ represents the i^{th} weight and c_{1,i} represents a status indicating how has the task used the i^{th} type of I/O devices of the second node in the time interval.

8. The method of claim 7, wherein the daemon periodically queries the status indicating how has the task used the i^{th} type of I/O devices of the first node in the time interval and the status indicating how has the task used the i^{th} type of I/O devices of the second node in the time interval to a kernel I/O Subsystem of an OS (Operating System).

9. The method of claim 1, wherein the first evaluation score is calculated by an Equation:
S1=Σᵢ₌₁^{m1}c_{1,i},
S1 represents the first valuation score, ml represents a total amount of types of I/O devices of the first node and c_{1,i} represents a status indicating how has the task used the i^{th} type of I/O devices of the first node in the time interval, and the second evaluation score is calculated by an Equation:
S2=Σᵢ₌₁^{m2}c_{2,i},
S2 represents the second valuation score, m2 represents a total amount of types of I/O devices of the second node and c_{1,i} represents a status indicating how has the task used the i^{th} type of I/O devices of the second node in the time interval.

10. The method of claim 1, wherein the daemon instructs a kernel affinity control interface of an OS (Operating System) to switch execution of the task to the processor of the second node.

11. An apparatus for determining processing nodes for executed tasks, comprising:
a first node, comprising a processor loading and executing a daemon and a task; and
a second node,
wherein the daemon obtains a first evaluation score associated with usages of I/O devices of the first node by the task in a time interval; obtains a second evaluation score associated with usages of I/O devices of the second node by the task in the time interval; and, when the second evaluation score is higher than the first evaluation score, switches execution of the task to a processor of the second node.

12. The apparatus of claim 11, wherein the daemon is a computer program that runs as a background task after system booting.

13. The apparatus of claim 11, wherein the first node comprises a first type of I/O devices and the second node comprises the first type of I/O devices and a second type of I/O devices.

14. The apparatus of claim 13, wherein the first type of I/O devices are storage devices and the second type of I/O devices are peripherals.

15. The apparatus of claim 11, wherein the daemon obtains an application associated with the task; and obtains I/O policies of a first type of I/O devices and a second type of I/O devices associated with the application.

16. The apparatus of claim 15, further comprising a storage device, wherein the daemon reads the I/O policies of the first type of I/O devices and the second type of I/O devices associated with the application from the storage device.

17. The apparatus of claim 15, wherein the I/O policies of the first type of I/O devices and the second type of I/O devices associated with the application comprises a first weight and a second weight, the first evaluation score is calculated by an Equation:
S1=Σᵢ₌₁^{m1}(wᵢ×c_{1,i}),
S1 represents the first valuation score, m1 represents a total amount of types of I/O devices of the first node, wᵢ represents the i^{th} weight and c_{1,i} represents a status indicating how has the task used the i^{th} type of I/O devices of the first node in the time interval, and the second evaluation score is calculated by an Equation:
S2=Σᵢ₌₁^{m2}(wᵢ×c_{2,i}),
S2 represents the second valuation score, m2 represents a total amount of types of I/O devices of the second node, wᵢ represents the i^{th} weight and c_{1,i} represents a status indicating how has the task used the i^{th} type of I/O devices of the second node in the time interval.

18. The apparatus of claim 17, wherein the daemon periodically queries the status indicating how has the task used the i^{th} type of I/O devices of the first node in the time interval and the status indicating how has the task used the i^{th} type of I/O devices of the second node in the time interval to a kernel I/O Subsystem of an OS (Operating System).

19. The apparatus of claim 11, wherein the first evaluation score is calculated by an Equation:
S1=Σᵢ₌₁^{m1}c_{1,i},
S1 represents the first valuation score, m1 represents a total amount of types of I/O devices of the first node and c_{1,i} represents a status indicating how has the task used the i^{th} type of I/O devices of the first node in the time interval, and the second evaluation score is calculated by an Equation:
S2=Σᵢ₌₁^{m2}c_{2,i},
S2 represents the second valuation score, m2 represents a total amount of types of I/O devices of the second node and c_{1,i} represents a status indicating how has the task used the i^{th} type of I/O devices of the second node in the time interval.

20. The apparatus of claim 11, wherein the daemon instructs a kernel affinity control interface of an OS (Operating System) to switch execution of the task to the processor of the second node.
